(19) United States
(12) Patent Application Publication
(10) Pub. No.: US 2012/0234706 A1
(43) Pub. Date: Sep. 20, 2012

(54) Ski/Snowboard Carrying Bag

(76) Inventor: John Edward Underfer, Franklin Lakes, NJ (US)

(21) Appl. No.: 13/421,818

(22) Filed: Mar. 15, 2012

Related U.S. Application Data
(60) Provisional application No. 61/452,899, filed on Mar. 15, 2011.

(51) Int. Cl. A63C 11/00; B62B 1/00; B65D 85/18

(52) U.S. Cl. 206/278; 206/315.1; 280/47.17

(57) ABSTRACT

A bag for transporting and storing skis, snowboards, and related accessories, such as helmets, boots, gloves, and goggles, where the bag has an elongated lower compartment for the storage and transport of skis and snowboards, and at least one separate upper compartment for the storage and transport of accessories. The lower compartment prevents the moisture on the skis and snowboards from reaching the helmets and gloves. The upper compartment may be divided into separate subcompartments, allowing boots to be kept separate from helmets and gloves, which can aid in keeping the moisture and/or odor of the boots from affecting the helmets and gloves. The bag is made of durable flexible material and is closed by zippers or other secure fasteners.

### FIELD OF INVENTION

The invention is a carrying bag for skis, snowboards and related equipment and accessories.

### BACKGROUND OF THE INVENTION

For many sports, part of the effort involved in participating in the sport includes managing the transportation of the equipment required to participate. For many sports, a simple bag is often sufficient, however for many sports, the use of a simple bag with a single storage compartment would result in dirt or liquids from one piece of equipment getting on other previously-clean pieces of equipment. A clear example of this problem arises with the sports of skiing and snowboarding. After use, skis, snowboards and boots usually have residual snow and ice on them, often frozen so that removal is difficult. It is usually not convenient to wait for the snow and ice to melt before packing the equipment away. Skiing and snowboarding also involve the use of helmets, gloves and goggles, and it is desired to keep those accessories from getting wetter.

While it is well known to use bags for transporting skis without other accessories, it would be easier for a user to have a single bag to carry all related equipment together, without the risk of snow or ice getting from the skis, snowboard or boots onto the user's helmet or gloves.

The object of the present invention is to provide a single bag for transporting skis, snowboards, boots, and related accessories, with the advantage of keeping the snow and ice from getting in contact with the related accessories.

### SUMMARY OF THE INVENTION

The invention is a bag developed to carry skis or snowboards, along with boots, helmet, and necessary gear in a convenient to better accommodate the end user, while providing an organized and secure storage bag for transporting and storing. The bag has at least one elongated compartment for storing and carrying skis and/or snowboards, and at least one compartment for storing and carrying boots, helmets and other accessories. The bag has at least one carrying strap.

### BRIEF DESCRIPTION OF THE DRAWINGS

FIG. 1 is a top perspective view of a preferred embodiment of the invention.

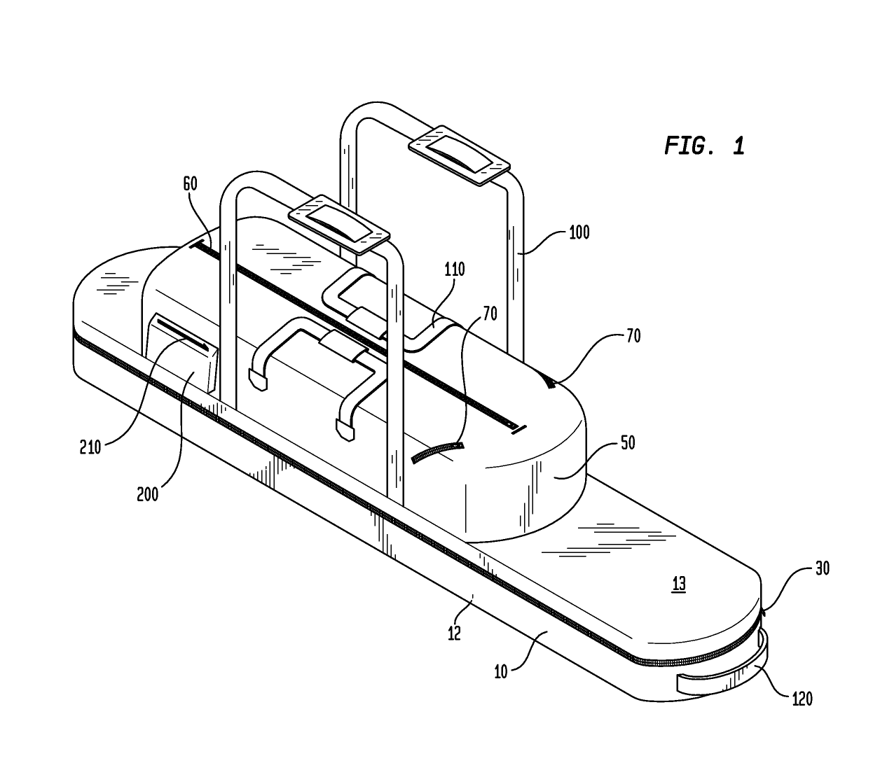

FIG. 2 is a side view of a preferred embodiment of the invention.

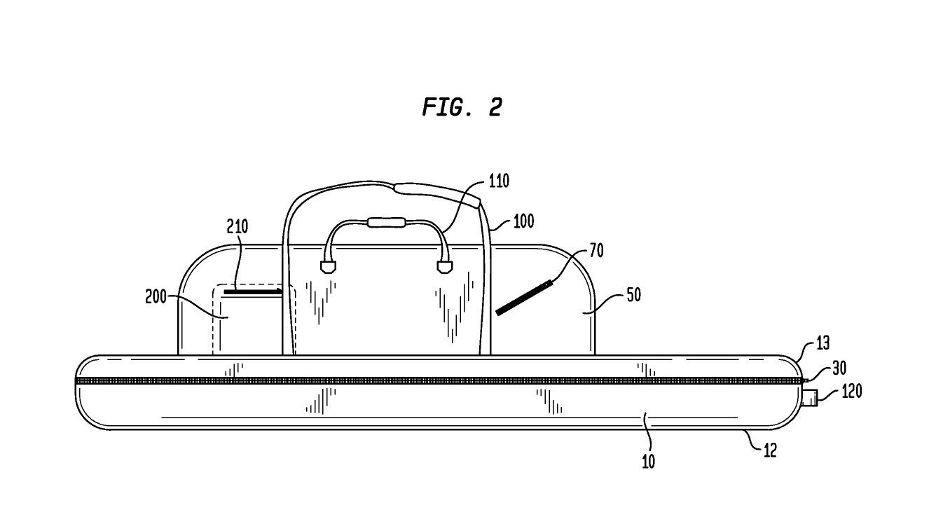

FIG. 3 is a top view of a preferred embodiment of the invention.

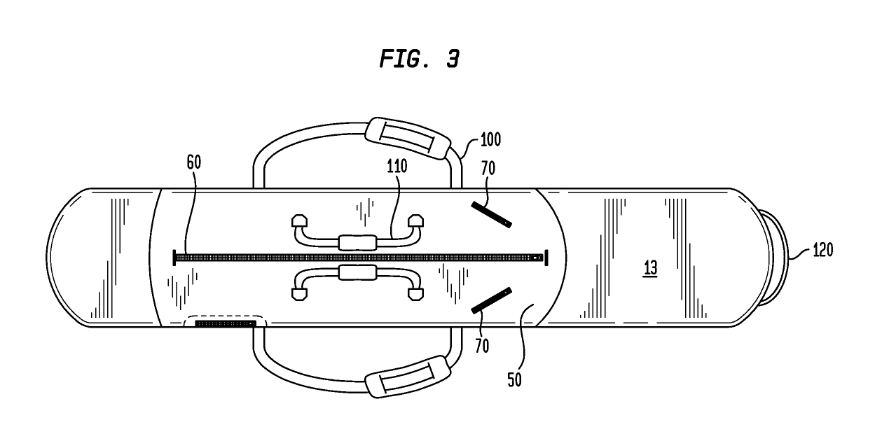

FIG. 4 is a side cross-sectional view of a preferred embodiment of the invention.

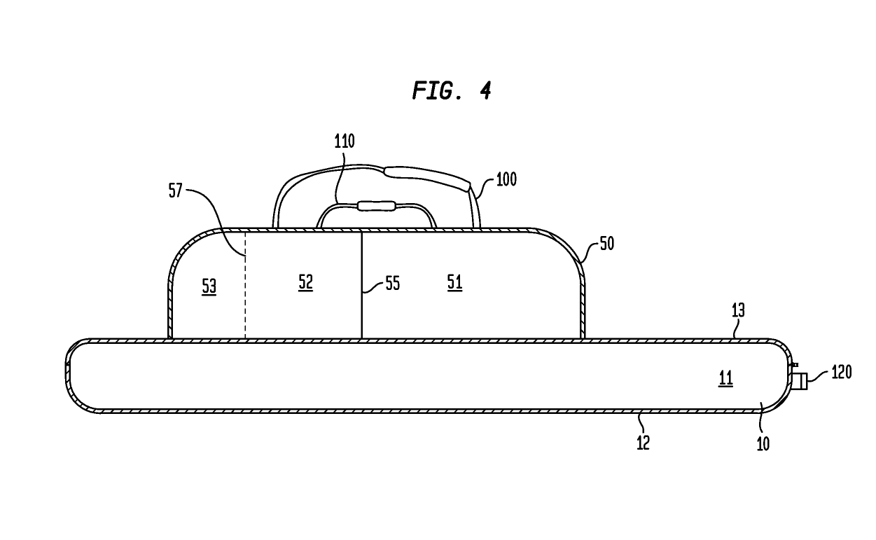

FIG. 5 is a top view of a preferred embodiment of the invention, showing in phantom objects stored inside.

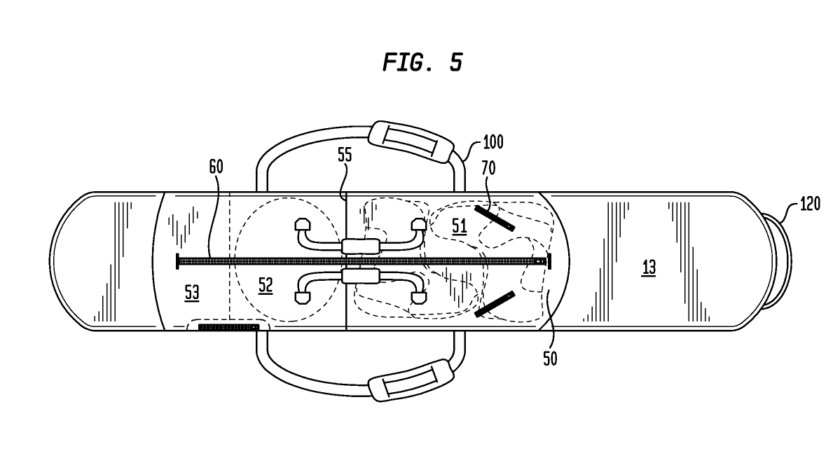

### DETAILED DESCRIPTION OF THE PREFERRED EMBODIMENT

The bag of the present invention has at least one lower compartment 10 for storing and carrying skis and/or snowboards, and at least one upper compartment 50 for storing and carrying boots, helmets and/or other accessories.

The lower compartment 10 is elongated, preferably of a length sufficient to accommodate at least one snowboard. The preferred width of the lower compartment 10 is sufficient to accommodate at least one ski. In the preferred embodiment, the lower compartment 10 is both long enough and wide enough to accommodate the lengths and widths of skis and snowboards. Preferably, lower compartment 10 is constructed of a bottom panel 12, with sides curving upward, and an upper panel 13, with sides curving downward. The sides of panels 12 and 13 meet together at closure means 30.

Closure means 30 preferably runs longitudinally between bottom panel 12 and upper panel 13. In the preferred embodiment, closure means 30 is a heavy duty zipper, capable of remaining closed under pressure loads of 30 pounds or more. The closure means 30 provides access to the lower compartment 10 in order to safely place skis or snowboard in lower compartment 10 for protected storage for transportation. The closure means 30 for the lower compartment 10 preferably runs the majority of the length of the lower compartment 10. Using the majority of the length of the lower compartment 10, a user may open up lower compartment 10 with closure means 30, fold over the upper panel 13 to gain access to the open space 11 within lower compartment 10, place their skis and/or snowboard(s) inside the lower compartment 10 and the close the lower compartment 10 using the closure means 30.

The lower compartment 10 may also comprise internal securing means, such as straps or hooks for retaining the skis or snowboards within the lower compartment 10 and restrict movement of such objects within the lower compartment 10. The lower compartment 10 may also have ventilation or drainage openings to allow water to drain out of the bag. As an additional feature, the bottom and side walls may be padded to help avoid damage during transportation.

The upper compartment 50 has at least one main storage area 51 capable of storing and carrying ski boots, snowboard boots, ski/snowboard helmets or other gear. The main storage area 51 may be one contiguous space, or may be separated into two or more sub-compartments 52 by internal partitions 55. The upper compartment 50 may also comprise additional storage areas or compartments 200.

The compartments of the bag have securable closure means, such as zippers, to close each compartment to keep the items secure.

Upper compartment 50 has closure means 60, preferably running the length of the upper compartment 50 to allow maximum access to the upper compartment 50 and any internal sub-compartments 52. The side external compartments 200 are provided for extra storage of accessories and essentials.

In the preferred embodiment, the upper compartment 50 has a first upper storage area 51 designed for storing boots. The first upper storage area 51 has water resistant sides, including internal partition 55 in order to keep any moisture and odor from the boots from entering other compartments. The upper storage area 51 is preferably located in the middle of the bag to aid in balance for carrying with shoulder strap and hand strap.

The upper compartment 50 preferably has a second upper storage area 52 designed for storing a helmet. The upper compartment 50 may also have a third upper storage area 53 for storing additional gear and accessories. A partition 57 between the second and third upper storage areas 52 and 53 may be made of a mesh material to permit air flow between the two upper storage areas 52 and 53. The inner netting partition 57 may be flexible to allow for the helmet or gear compartments to expand as necessary.

The first upper storage area 51 may also have ventilation holes or openings 70 to allow drainage of moisture or release of odor. Ventilation holes 70 may be secured by closure means, such as zippers or snaps. Preferably any ventilation holes would be secured by closure means, so that the user may control when any liquid drains out of the bag.

The bag may have additional storage compartments or pockets of varying sizes, as well as external clips and loops for attaching items to the bag.

The bag has straps that are strategically located for maximum balance while carrying. The bag may be equipped with multiple carrying straps, including longer straps 100 for supporting the bag on a shoulder, short straps 110 for carrying the bag by had, and a front strap 120 located on nose to aid in carrying or standing upright. The shoulder straps 100 and hand straps 110 may have a cushioned pad to add comfort for the user and help in balancing the bag. The bag may have external clips, such as D-rings, for attaching straps at variable locations to help balance the bag when loaded.

The bag is preferably made from a durable canvas or similar that is flexible enough to allow the bag to be rolled up or folded for easy storage when not in use. The lower compartment 10 may be made of a heavier grade material than the upper compartment, to support the weight of the equipment and prevent punctures.

As an additional feature, the bag may also include wheels or rollers on the bottom to assist the user in transporting the bag.

While certain novel features of the present invention have been shown and described, it will be understood that various omissions, substitutions and changes in the forms and details of the device illustrated and in its operation can be made by those skilled in the art without departing from the spirit of the invention.

I claim:

1. A bag for carrying sporting equipment, comprising
an elongated bottom component, with two long sides and two short sides, where the long sides and short sides rise up from a bottom plane;
an elongated middle component with two long sides and two short sides, forming a middle plane;
where one long side of the elongated bottom component is fixedly attached to a long side of the elongated middle component, along a portion of the respective lengths of the two long sides;
where the remaining lengths of the two long sides of the elongated bottom component and elongated middle component, and the corresponding short sides and other long sides of the elongated bottom component and elongated middle component are attached to each other in a removable manner by a first closure means;
where a lower compartment is formed in a space between the elongated bottom component and elongated middle component with their respective sides attached;
at least two upper side panels, each upper side panel having a bottom edge fixedly attached to the middle plane of the elongated middle component and a closure end;
where the closure ends of the two upper side panels are attached to each other in a removable manner by a second closure means; and
where an upper compartment is formed in a space between the two upper side panels and the middle plane of the elongated middle component.

2. The bag of claim 1, where the lower compartment is capable of storing at least one ski or snowboard.

3. The bag of claim 1, where the upper compartment is capable of storing at least one pair of ski or snowboard boots.

4. The bag of claim 1, where the upper compartment further comprises:
at least one dividing panel extending from one upper side panel to the other upper side panel, dividing the upper compartment into at least two storage sub-compartments.

5. The bag of claim 4, where the dividing panel is formed of an elastic material.

6. The bag of claim 1, further comprising:
a support strap.

7. The bag of claim 1, further comprising:
a ventilation opening in the lower compartment.

8. The bag of claim 1, further comprising:
a second ventilation opening in at least one of the upper side panels.

9. The bag of claim 1, further comprising:
at least one wheel attached to the elongated lower side panels.

10. The bag of claim 1, where the elongated bottom component is formed of a durable flexible material.
